(19) United States
(12) Patent Application Publication
(10) Pub. No.: US 2025/0091057 A1
(43) Pub. Date: Mar. 20, 2025

(54) ROTOR FOR A LABORATORY CENTRIFUGE

(71) Applicant: Thermo Electron LED GmbH, Osterode (DE)

(72) Inventor: Norman BALLHAUSE, Osterode (DE)

(21) Appl. No.: 18/855,817

(22) PCT Filed: Apr. 5, 2023
(86) PCT No.: PCT/EP2023/058924

§ 371 Date: Oct. 10, 2024

(30) Foreign Application Priority Data
Apr. 13, 2022 (DE) 22168241.2

(51) Int. Cl. B04B 5/04; B01L 9/06; B04B 7/08

(52) U.S. Cl. CPC B04B 5/0414; B01L 9/06; B04B 7/08; B04B 7/085; B04B 2005/0435

(57) ABSTRACT

Rotor (1) for a laboratory centrifuge comprising a rotor body (10), which is foreseen to be placed in the laboratory centrifuge and rotationally driven, wherein the rotor body (10) has a non-cylindrical shape, and wherein the rotor (1) is foreseen to carry sample containers (30) reaching into a circumferential bulge (15) of the rotor body (10), wherein it is foreseen that the rotor (1) further comprises an interchangeable circular adapter (20, 20′, 20″) held within the rotor body (10), wherein receptacles for respective sample containers (30) are comprised within the rotor body (10) and/or the adapter (20, 20′, 20″). Adapter (20, 20′, 20″) for use within a rotor (1) and Laboratory centrifuge with a rotor (1) according to the above.

The invention pertains to a rotor for a laboratory centrifuge with an adapter for receiving sample containers the adapter for the rotor and a laboratory centrifuge with such a rotor.

The invention lies in the technical field of centrifuge rotors and more specifically in the adaptation of centrifuge rotors to sample carriers or sample containers (such as sample tubes).

An application for laboratory centrifuges is the separation of substances of higher and lesser density by the principle of sedimentation. Laboratory centrifuges therefore comprise rotors which have receptacles for sample containers. The rotors are rotationally driven by a driving mechanism of the laboratory centrifuge. The rotors commonly have a circular outer shape in order to avoid or reduce vibrations during rotation. The sample containers are in most cases arranged in respect to a circumference of the rotor. When the rotor is rotationally driven around the central axis, a centripetal acceleration is exerted on the sample containers and the samples therein. In that way, it is possible to exert forces on the samples which are by several orders of magnitude higher than achievable under gravitational acceleration. In certain applications, rotors need to be sealed with lids, wherein the seal is required to be liquid, aerosol or gas tight in order to prevent injury of the user of the centrifuge before and after the centrifugation and in order to avoid contamination.

DE 10 2005 014 218 A1 shows an exemplary embodiment of a rotor, wherein the rotor displayed in DE 10 2005 014 218 A1 is a fixed-angle rotor. The samples are oriented around a circumferential direction and held within receptacles arranged within a bulge section of the rotor. The sample containers are held in respect to the rotational axis at a fixed angle within the receptacles. The rotor is designed to receive sample containers of a certain size. The receptacles have therefore a shape (e.g. are embodied as bores for essentially cylindrical sample tubes) to accommodate the sample containers. The design of the rotor and especially the sample receptacles is specific for a certain size of sample containers. It is possible to reduce the size of the sample receptacles by way of adapter sleeves or bushings. However, it is not possible to increase the size of the receptacles of a specific rotor for larger sample containers without changing the rotor itself to a rotor with larger dimensioned sample container receptacles. The use of adapter sleeves or bushings for adapting the receptacles of a given rotor to smaller dimensioned sample containers has moreover the disadvantage that handling is more complicated. Thus, cycle times in analysis are increased. Additionally, there is room for failure, e.g. in case an adapter sleeve or bushing is omitted for a given sample container. Also the application of the adapter sleeve or the bushing may be a further source for accidents e.g. spillages during the application of the sample container. In particular, the handling of adapter sleeves or bushings is inconvenient and time consuming e.g. in the case where 24 adapter sleeves or bushings need to be mounted for a 24-place rotor. Additionally, adapter sleeves or bushings might easily get lost, which may impede the process chain of an analysis.

Another possibility to adapt a rotor to the size of sample carriers is the use of drum rotors, where cage-like inserts or inserts of a partial cylindrical shape are placed within. Drum-like rotors may however exhibit a lower efficiency in terms of space usage, so the operation efficiency of the centrifuge may be impeded. The cylindrical outer shape does create high air friction on the outer surface during the operation of the centrifuge, while the typical frustoconical shape of fixed angle rotors as shown in DE 10 2005 014 218 A1 has advantages in terms of friction due to the reduced angular velocity of the skin portions with a smaller diameter. Thus, a motor with a higher power rating is required to turn the cylindrical rotor, which also affects the cooling system, as also a higher cooling performance required. The overall centrifuge system has a higher power consumption when cylindrical rotors are employed. Cylindrical drum like rotors need either to be designed with thicker walls to withstand the forces in the centrifuge (which also affects the efficiency for the reasons above) or are mechanically less stable than the fixed-angle rotors as displayed above.

Thus, the problem to be solved is to foresee a rotor which easily adaptable to a wide range of sample carriers without having to sacrifice advantages in rotor design.

The invention described herein is associated with an improved rotor according to claim 1, as well as according to claim 14 with an adapter for use in such a rotor and, according to claim 15 with a centrifuge employing such a rotor.

The invention pertains to a rotor for a laboratory centrifuge comprising a rotor body, which is foreseen to be placed in the laboratory centrifuge and rotationally driven, wherein the rotor body has a non-cylindrical shape, and wherein the rotor is foreseen to carry sample containers reaching into a circumferential bulge of the rotor, wherein the invention foresees that the rotor further comprises an interchangeable circular adapter held within the rotor body, wherein receptacles for respective sample containers are comprised within the rotor body and/or the adapter.

The non-cylindrically shaped rotor is preferably a fixed-angle rotor and may have a frustoconical shape. The diameter at an upper opening is thereby smaller than the diameter at an opposed bottom side of the rotor. The outer shell of such a preferably rotor is rotationally symmetrical. The non-cylindrical shape has the advantage that the air friction is lowered during the rotation of the rotor in the laboratory centrifuge compared to a pure cylindrical shape of the rotor. Especially the frustoconical shape has a reduced of a typical fixed-angle rotor has surface area which is smaller than a cylindrical rotor having the largest diameter of a comparable fixed-angle rotor. The non-cylindrical shape thus contributes to the overall efficiency of the centrifuge or allows for the same rotational speeds compared to cylindrical rotors while needing a smaller driving power. In a further optional development of the invention, the rotor comprises a plurality of sample receptacles around a circumferential path. The sample receptacles may be embodied as bores, which are extending from an inner space of the rotor into the direction of the outer shell. The bores may be angled against a central rotational axis of the rotor. The bores do not extend through the outer shell and are thus preferably embodied as blind bores. The rotor may be detachably coupled to a laboratory centrifuge via a central hub section, which is arranged concentrically to the rotational axis of the rotor. The receptacles for the sample containers being comprised within the adapter and the rotor body has the technical effect, that the samples are securely held within the rotor body and the adapter. The dependency of the rotor on the sample container size is advantageously mitigated by foreseeing that the sample receptacles are only contained in the adapter. By changing the adapter, the sample receptacle contained within the adapter may also be changed. In that way, the rotor is conveniently adaptable to differently-sized sample containers by way of interchanging the adapter. In that way, a universal rotor body may be foreseen while the rotor with the adapter offers the possibility of operating different types of sample containers such as 5 ml, 2 ml, 1.5 ml, or PCR strips in such a rotor by changing adapters and keeping the traditional shape of the rotor with the advantages as described above.

According to a further aspect of the invention, it is foreseen that the adapter is embodied as adapter disc, which is coaxially oriented in respect to the rotor body. The adapter disc is preferably inserted via an upper opening into the rotor body. Providing the adapter as a disc has advantages in the mass distribution within the rotor. This ensures a smooth rotation of the rotor once it is rotationally driven by the laboratory centrifuge.

Another aspect of the invention foresees that the adapter is rotationally secured to the rotor body via a form fit, and wherein the adapter is axially removable from the rotor body. In particular, it may be foreseen that the adapter has an outer shape which corresponds with an inner shape of the inner space of the rotor. According to a further development of the aspect, the adapter may foresee a central opening which corresponds to the hub section of the rotor. The form fit may be embodied between the adapter and the hub section of the rotor body. The form fit may be alternatively or additionally embodied between an outer circumference of the adapter and an inner circumference of the inner space of the rotor body. According to a further development of this aspect, the form fit may be alternatively or additionally embodied between a bottom side of the adapter and an inner bottom of the rotor body. The adapter may foresee protrusions and/or recesses on the bottom side, which engage with protrusions and/or recesses on the inner bottom of the rotor body. After an alternative or additional further aspect, the form fit may also be established between protrusions reaching from the adapter disc into bores arranged in the circumferential bulge of the rotor body. Establishing a rotationally securing form fit between the adapter and the rotor body has the technical effect, that the adapter may be brought into a rotationally secure position in respect to the rotor body. This prevents a misalignment of the adapter to the rotor body. According to a further beneficial aspect of the invention, it is ensured by the form fit, that the receptacles of the adapter are aligned to the receptacles of the rotor body.

According to a further aspect of the invention, it is foreseen that the adapter is of a one-piece design. A one-piece design is easy to maintain and to insert into the rotor body, while maintaining a high degree of mechanical stability.

Another aspect of the invention foresees that the receptacles of the rotor body are bores protruding in the circumferential bulge of the rotor body and the receptacles in the adapter are holes concentrically aligned to the bores in the rotor body, wherein the cross section of a respective bore is greater or equal to the cross section of the respective concentrically aligned hole. The bores in the rotor body are preferably embodied as blind bores. The bores and holes are preferably round, wherein the diameter of a respective bore is greater or equal to the diameter of the respective concentrically aligned hole. However, the bores and holes may also have other shapes, depending on the shape of the employed sample container. Keeping the dimensioning of a respective bore greater or equal to the dimensioning of the respective concentrically aligned hole has the advantage that the size of the largest possible sample container usable with the rotor is only governed by the dimension of the bores within the rotor body. The adapter may have holes with smaller dimensions (e. g. diameter). In that way, the rotor is easily adaptable for differently sized sample containers between the smallest possible dimension of the holes in the adapter and the largest possible dimension of the bore within the rotor body.

According to a further aspect of the invention it is foreseen that the receptacle within the rotor body is an annular shaped canal within the circumferential bulge of the rotor, wherein the annular shaped canal the extends along a circumferential direction in respect to the rotor. According to a further development of this aspect, it is foreseen that the sample containers are only held within the receptacle of the adapter. This allows for the receptacles being oriented along the circumferential direction as needed. In case of smaller dimensions, the adapter may comprise more receptacles along the circumferential direction. The sample containers may reach through the adapter into the annular shaped canal. However, the canal does not predetermine the position of the sample container. In this preferred aspect of the invention, the arrangement of the sample containers is solely determined by the arrangement of the receptacles of the adapter.

After another aspect of the invention it is foreseen that the receptacles within the adapter are in a circular arrangement. A circular arrangement of the receptacles allows for an even mass distribution in respect to the rotor and in particular in respect to the rotational axis of the rotor.

According to another aspect, the invention may foresee that the receptacles within the adapter are in a rectangular arrangement. A rectangular arrangement is in particular advantageous if sample containers are chained and are to be inserted linked together. In particular, sample containers which are employed in an automatic or semi-automatic analysis chain may be linked together. The rectangular arrangement of the receptacles allows for the employment of such linked or chained sample containers and allows the employment of the rotor in automatic or semi-automatic analysis chains.

According to a further aspect of the invention it is foreseen that the rotor body has more than one row of circumferentially aligned receptacles and the adapter has more than one row of circumferentially oriented receptacles, wherein the receptacles of the adapter are concentrically aligned to the receptacles of the rotor body. After a further development of the aspect, it may be foreseen that the receptacles of the adapter are embodied as holes and the receptacles of the rotor body are embodied as bores, preferably as blind bores and dimensioned as described above. In that way, the capacity of the rotor may be increased without significantly increasing the size of the rotor body.

According to another aspect of the invention, the rotor may have the adapter, which is rotationally secured within the rotor body via a slot and key arrangement, wherein the slot and key arrangement comprises slots in a hub section of the rotor and keys in a central area of the adapter, or vice versa. This allows for an easy insertion and removal of the adapter. The adapter may be conveniently swapped against an other adapter with differently dimensioned receptacles for the use with accordingly sized sample containers.

Accordingly, it is foreseen in a further aspect of the invention in that the adapter has a mantle surface which is tapered to a side of the adapter facing the rotor body and the rotor body is tapered to match the tapered mantle surface of the adapter. The tapering of the mantle surface allows for an easy insertion of the adapter into the rotor body on one hand and also mitigates a canting and thus blocking of the adapter in the rotor body on the other hand. Especially, during centrifugation, the adapter may deform slightly. The tapering of the mantle surface precents the canting of the adapter against the rotor body also under these circumstances. The tapering may be in a range of 1 to 5 degrees against the vertical which is given by the rotational axis of the rotor.

Another aspect of the invention foresees that a material of the adapter comprises a plastic material or a fibre-reinforced plastic material. The adapter may be preferably manufactured by injection moulding. Such adapters are easy to produce, which allows to use a larger number of adapters with differently sized and/or arranged receptacles with a single rotor without significantly increasing the cost due to the adaptation of the rotor. Since the adapter is held within the rotor body, the structural integrity of the whole assembly is governed by the rotor body. The use of fibre-reinforced plastic material may be beneficial for applications where high rotational speeds or centripetal accelerations are to be achieved by the laboratory centrifuge.

According to a further aspect of the invention it may be foreseen that a material of the rotor body comprises Aluminium or a carbon fibre material. The rotor body needs to withstand mechanical stresses during rotation, while the rotor body needs to be as light as possible so as to not impede the efficiency of the centrifuge. Carbon fibre material or Aluminium are exemplary materials with material properties fulfilling these specifications.

The invention also pertains to an adapter for use within a rotor and to a laboratory centrifuge with a rotor according to the above. The above-mentioned advantages also apply for the adapter and the laboratory centrifuge with the rotor according to the invention.

The invention will now be described in relation to the following non-limiting figures. Further advantages of the disclosure are apparent by reference to the detailed description when considered in conjunction with the figures in which:

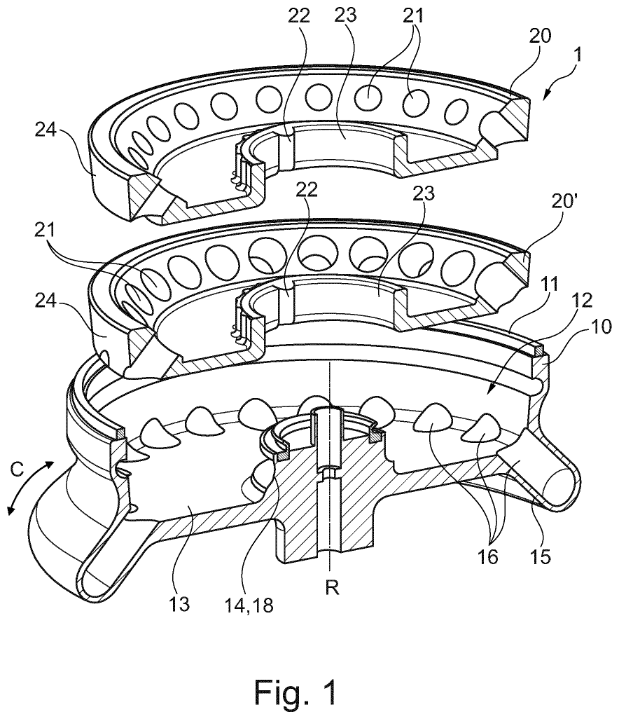

FIG. 1 shows a schematic, sectioned perspective view of the rotor with a rotor body and two different adapters;

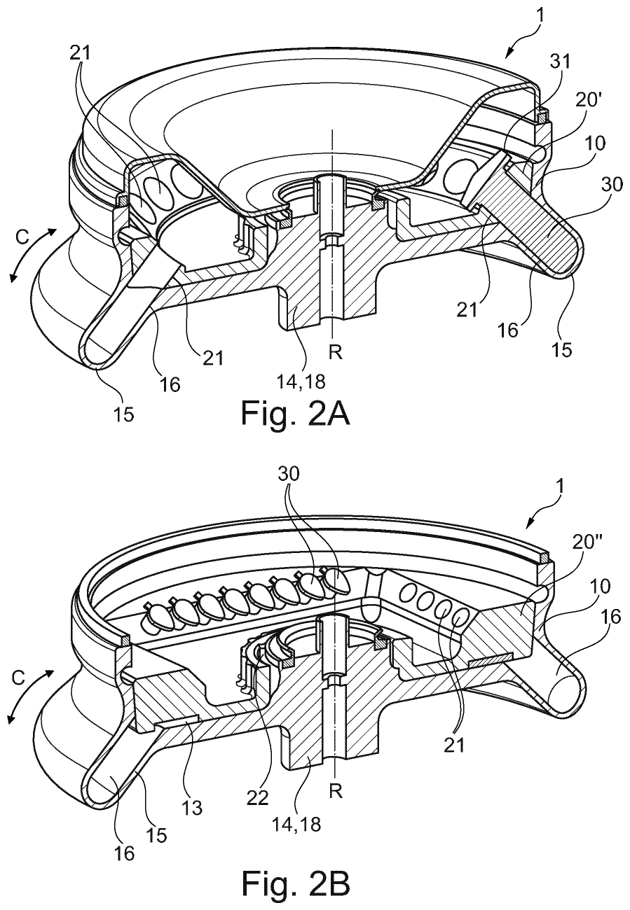

FIG. 2A shows a schematic, sectioned perspective view of the rotor with a rotor body, an adapter and an inserted sample container according to a first embodiment;

FIG. 2B shows a schematic, sectioned perspective view of the rotor with a rotor body, an adapter and an sample containers according to a second embodiment;

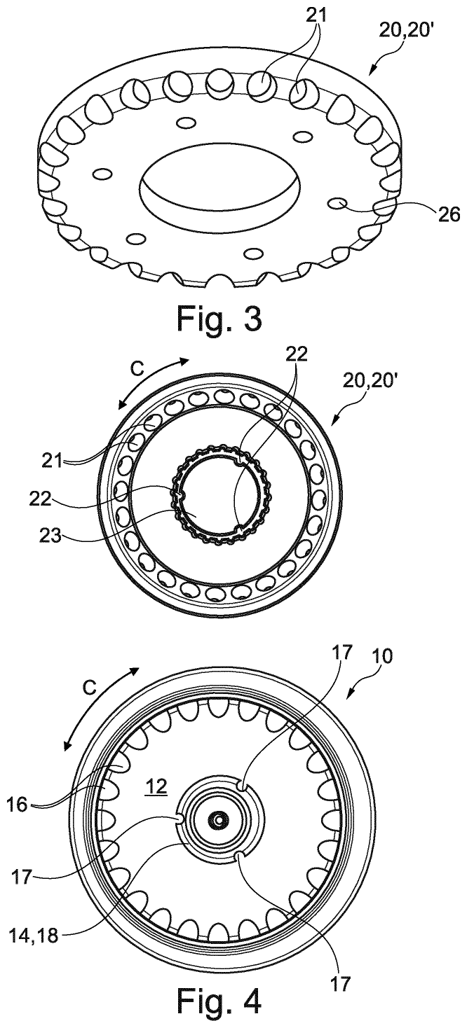

FIG. 3 shows a schematic, perspective view of an adapter; and

FIG. 4 shows a schematic view of the interlock between an adapter and a rotor body.

Unless otherwise noted, reference numerals always specify the same element throughout all figures.

FIG. 1 shows a schematic, sectioned perspective view of the rotor 1 with a rotor body 10 and two different adapters 20, 20′. Wherein one of the adapters 20, 20′ is to be placed in a rotor body 10 of the rotor 1. The rotor body 10 has an upper opening 11 and an inner space 12. The rotor body 10 has essentially a frustoconical outer shape and a circumferential bulge 15 into which receptacles of the rotor extend. The receptacles are embodied in the rotor body 10 as blind bores 16 and are arranged evenly spaced around a circumferential direction C of the rotor 1. The receptacles of the rotor body 10 are angled in respect to the rotational axis R of the rotor 1 and all have the same first diameter. The rotor 1 is a fixed angle rotor. The diameter of the bores in the rotor body 10 may be adapted to accompany a largest dimensioned sample container 30 which is to be employed with the rotor. The first diameter may e.g. be the diameter of a 2 ml or 5 ml sample tube. The inner space 12 of the rotor 1 has a bottom 13, which extends radially from a central hub section 14 of the rotor body 10 in the direction of a perimeter of the rotor body 10.

From FIG. 1, it can be seen that the adapters 20, 20′ are placed axially within the inner space 12 of the rotor body 10, wherein the adapter 20, 20′ have a bottom surface 25 which abut the bottom 13 of the rotor body 10. The adapter 20, 20′ have at least one radially protruding key 22 in an open central area 23, the key 22 being axially oriented in respect to the rotational axis R of the rotor 1. The key 22 is engageable with a slot 17 in the hub section 14 of the rotor body 10 to establish a form fit, which rotationally secures the adapter 20, 20′ within the rotor body (cf. FIG. 4 for details).

FIG. 1 shows two adapters 20, 20′, wherein the adapters 20, 20′ differ in the embodiment of the holes 21 forming the sample container receptacles within the respective adapter 20, 20′. The first adapter 20 has holes 21 which are concentrically oriented to the bores 16 of the rotor body 10 when the adapter 20 is in form fit with the rotor body 10. The holes 21 have a smaller diameter than the diameter of the bores 16 of the rotor body 10. This allows for sample containers 30 (not pictured) to be used with the rotor 1, which have a smaller size (diameter) than the bore 16 of the rotor body 10. With this adapter 20, the sample containers 30 are held in the adapter 20 and in floating support within the rotor body 10: the support of the sample container 30 is only given by the adapter 20, the rest of the length hangs freely in bore 16 of the rotor body 10. The sample containers 30 are retained in respect to the receptacles by their neck section 31 which abuts the adapter 20.

The rotor 1 may be easily adaptable to larger sized sample containers 30 by switching the first adapter 20 to the second adapter 20′. The second adapter 20′ has holes 21 with a larger diameter than the first adapter 20. The diameter of the holes of the second adapter 20′ is the same diameter as the diameter of the bores 16 of the rotor body 10. When the second adapter 20′ is placed into the rotor body 10 and engaged with the form fit, the holes 21 of the second adapter 20′ are likewise oriented concentrically to the bores 16 of the rotor body 10. For this adapter 20′, the diameter of the holes 21 and the bores 16 of the rotor body 10 is the same, which is the maximum diameter or dimension of the receptacle. A sample container 30 would be received and held within the respective hole 21 and the bore 16 (see also FIG. 2A in that regard).

The respective adapter 20, 20′, 20″ has a mantle surface 24 which is tapered to a side of the adapter 20, 20′, 20″ facing the rotor body 10 and the rotor body 10 is tapered to match the tapered mantle surface 24 of the adapter 20, 20′, 20″. The tapering is in a range of 1 to 5 degrees against the vertical which is given by the rotational axis R of the rotor 1. The tapering of the mantle surface 24 allows for an easy insertion of the adapter 20, 20′, 20″ into the rotor body 10 on one hand and also mitigates a canting and thus blocking of the adapter 20, 20′, 20″ in the rotor body 10 on the other hand.

FIG. 2A shows a schematic, sectioned perspective view of the rotor 1 with a rotor body 10, an adapter 20′ and an inserted sample container 30 according to a first embodiment. This embodiment shows the second adapter 20′ referred to in FIG. 1 being placed in the rotor body 10. From FIG. 2A, it can be seen that the sample container 30 is held within the adapter 20′ and the rotor body 10, because the inserted diameter of the sample tube 30 corresponds to the diameter of the hole 10 in the adapter 20′ and the diameter of the bore 16 rotor body 10 forming the receptacle for the sample container 30. Here, it can also be seen that the sample container 30 abuts the adapter 20′ with a neck section 31 of the sample container 30. In this embodiment, the sample container 30 completely fills the length of the receptacle formed by the hole 21 of the adapter 20′ and the bore 16 in the rotor body 10. It might as well be that the sample container 30 is shorter than the prescribed length.

FIG. 2B shows an alternative embodiment of an adapter 20″ placed in the rotor body 10. The adapter 20″ has holes 21 acting as receptacles for strips of sample containers 30, such as PCR-strips. The holes 21 are in a rectangular arrangement. In this embodiment, the sample containers 30 are exclusively held within the adapter 20″. Thus, the receptacles of the rotor 1 for the sample containers 30 do not extend into the rotor body 10.

FIG. 3 shows a schematic, perspective view of an adapter 20, 20′ from the bottom side. From FIG. 3, it can be seen that the holes 21 within the adapter 20, 20′ are circumferentially oriented and evenly spaced. It can also be seen that the adapter 20, 20′ is disc shaped. The adapter has dimples 26 in the bottom surface 25, which are meant to engage with grooves in the bottom 13 of a not pictured rotor body 10 when the adapter 20, 20′ is placed in the inner space 12 of the rotor body 10. The dimples 26 and grooves are another embodiment of a form fit, which contributes to rotationally securing the adapter 20, 20′ within the rotor body 10.

FIG. 4 shows a schematic view of the interlock between an adapter 20, 20′ and a rotor body 10, wherein a form fit is established between a slot-and-key engagement in the hub section 14 of the rotor body 10. The hub 18 of the rotor body 10 has radially open slots 17 extending in an axial direction parallel to the rotational axis R of the rotor 1. In this embodiment, the hub 18 has three of the slots 17 arranged around the circumference of the hub 18. In a radially inward direction, the adapter 20, 20′ has three protrusion formed as keys 22 of the slot and key arrangement which also extend in an axial direction parallel to the rotational axis R of the rotor 1. The keys 22 of the adapter 20, 20′ engage with the slots 17 of the rotor body 10, thus locking the adapter 20, 20′ rotationally when inserted into the inner space 12 of the rotor body 10. Additionally, the slot 17 and key 22 engagement defines the orientation of the adapter 20, 20′ to the rotor body 10, wherein the holes 21 of the adapter 20, 20′ are always concentrically oriented to the bores 16 in the rotor body 10.

It will be appreciated that the present disclosure is not limited to the embodiments described above and that modifications and variations on the embodiments described above will be readily apparent to the skilled person. Features of the embodiments described above may be combined in any suitable combination with features of other embodiments described above as would be readily apparent to the skilled person and the specific combinations of features described in the above embodiments should not be understood to be limiting. The dimple 26 and recess interlock as described for the embodiment according to FIG. 3 may e.g. be foreseen additionally or in exchange to the slot 17 and key 22 interlock as described in FIG. 4 and also present the embodiments according to FIGS. 1 and 2A to 2B.

List of reference signs

| | |
|---|---|
| 1 | rotor |
| 10 | rotor body |
| 11 | upper opening |
| 12 | inner space |
| 13 | bottom |
| 14 | hub section |
| 15 | circumferential bulge |
| 16 | bore |
| 17 | slot |
| 18 | hub |
| 20, 20′, 20″ | adapter |
| 21 | hole |
| 22 | key |
| 23 | central area |
| 24 | mantle surface |
| 25 | bottom surface |
| 26 | dimple |
| 30 | sample container |
| 31 | neck section |
| C | circumferential direction |
| R | rotational axis |

1. A rotor for a laboratory centrifuge, comprising:
a rotor body, which is configured to be placed in the laboratory centrifuge and rotationally driven,
wherein the rotor body has a non-cylindrical shape, and
wherein the rotor is configured to carry sample containers reaching into a circumferential bulge of the rotor body, the rotor further comprising an interchangeable circular adapter held within the rotor body, wherein receptacles for respective sample containers are comprised within the rotor body and/or the adapter.

2. The rotor according to claim 1, wherein the adapter is characterized as an adapter disc, which is coaxially oriented in respect to the rotor body.

3. The rotor according to claim 1, wherein in that the adapter is rotationally secured to the rotor body via a form fit, and wherein the adapter is axially removable from the rotor body.

4. The rotor according to claim 1, characterized in that the adapter is of a one-piece design.

5. The rotor according to claim 1, wherein the rotor body comprises receptacles characterized as bores protruding in the circumferential bulge of the rotor and the adapter comprises receptacles characterized as holes concentrically aligned to the bores in the rotor body, wherein the cross section of a respective bore is greater or equal to the cross section of the respective concentrically aligned hole.

6. The rotor according to claim 1, wherein the rotor body comprises a receptacle characterized as an annular shaped canal within the circumferential bulge of the rotor body, wherein the annular shaped canal extends along a circumferential direction in respect to the rotor.

7. The rotor according to claim 1, wherein the adapter comprises receptacles in a circular arrangement.

8. The rotor according to claim 1, wherein the adapter comprises receptacles in a rectangular arrangement.

9. The rotor according to claim 1, wherein the rotor body comprises a plurality of rows of circumferentially aligned receptacles, wherein the adapter comprises a plurality of rows of circumferentially oriented receptacles, and wherein the receptacles of the adapter are concentrically aligned to the receptacles of the rotor body.

10. The rotor according to claim 1, wherein the adapter is rotationally secured within the rotor body via a slot and key arrangement, wherein the slot and key arrangement comprises slots in a hub section of the rotor and keys in a central area of the adapter, or keys in a hub section of the rotor and slots in a central area of the adapter versa.

11. The rotor according to claim 1, wherein the adapter comprises a mantle surface which is-tapered to a side of the adapter facing the rotor body and the rotor body is tapered to match the tapered mantle surface of the adapter.

12. The rotor according to claim 1, wherein the adapter comprises a plastic material or a fibre-reinforced plastic material.

13. The rotor according to claim 1, wherein the rotor body comprises aluminium or a carbon fibre material.

14. An adapter, the adapter being configured for use within a rotor according to claim 1.

15. A laboratory centrifuge, comprising with a rotor according to claim 1.
